(19) United States
(12) Patent Application Publication
(10) Pub. No.: US 2026/0079004 A1
(43) Pub. Date: Mar. 19, 2026

(54) METHOD FOR INSPECTING PANELS, AND DEVICE USED FOR THIS

(71) Applicant: UNILIN, BV, Wielsbeke (BE)

(72) Inventors: Matti VANHESSCHE, Wielsbeke (BE); Stijn VAN NEVEL, Wielsbeke (BE); Christophe NAEYAERT, Wielsbeke (BE)

(21) Appl. No.: 19/110,503

(22) PCT Filed: Sep. 7, 2023
(86) PCT No.: PCT/IB2023/058842

§ 371 Date: Mar. 11, 2025

Related U.S. Application Data
(60) Provisional application No. 63/410,379, filed on Sep. 27, 2022.

(30) Foreign Application Priority Data
Oct. 13, 2022 (BE) 2022/5826
May 25, 2023 (DE) 20 2023 102 907.8

(51) Int. Cl. G01B 11/24; E04F 13/08; E04F 15/02

(52) U.S. Cl. CPC G01B 11/24; E04F 13/0894; E04F 15/02038; E04F 2201/0153; E04F 2201/023; E04F 2201/042; E04F 2201/043

(57) ABSTRACT

A process is for inspecting panels that have profiled edge areas with coupling parts. The process includes at least the step of recording at least the first and second parts of the contour of the cross-section of the first mentioned profiled edge areas. The first and second parts are recorded using one or more sensors. The recording of the first part is conducted from a first recording angle, while the recording of the second part is performed from a second recording angle that differs from the first recording angle. Each part is recorded from one or more transverse directions to the longitudinal direction of the corresponding edge. This method enables quality control on panels using such an inspection method and a device applied for this purpose.

The present invention relates to a method for inspecting panels, a method for performing a quality control on panels by means of such inspection, and a device employed therewith. In the context of the present invention, the primary concern is the inspection of decorative panels intended to be employed as panels of a floating installed floor covering. Other applications are not excluded, such as applications with panels that are glued to a substrate, or with wall or ceiling panels.

WO 97/47834 discloses decorative laminate floor panels which, at at least a first pair of opposite edges, are provided with profiled edge aeras which are provided with coupling parts that allow two panels of this kind to be coupled to each other, wherein the above-mentioned coupling parts are substantially made as a tongue and groove, wherein the groove is delimited by means of at least a top and a bottom groove lip and wherein the aforementioned tongue and groove are provided with locking parts which prevent the tongue and groove from moving apart, wherein in the coupled state a locking can be obtained in a direction perpendicular to the plane of the coupled panels, and in a direction in the plane of the coupled panels and perpendicular to the coupled edges. Panels of this kind are ideally suited for use in a floating floor covering. WO'834 further discloses that the contour of the profiled edge areas can be achieved by subjecting the panel with the corresponding edges to successive mechanical cutting operations with rotary milling tools. This involves a continue milling process, namely a process in which the panel is carried in a feed direction by the milling machine and thus with its edges over the rotary milling tools, which are otherwise fixedly positioned. In this process, the wear of the milling tools, the inaccuracy of the feed-through device and the forces exerted by the milling tools on the edges of the panel can lead to deviations in the aforementioned contour.

According to the state of the art, panels of this kind are inspected either by performing an installation test in which the coupling parts of several panels of this kind are inserted into each other, or by inserting a mould into the coupling part to be tested, or by performing destructive testings, in which a sample is taken transversely from the corresponding edge area, and inspected under a projector or another optical system from the longitudinal direction of the corresponding edge area. Such methods for inspecting panels are themselves error-prone, and highly dependent on the person performing the test. For example, in the installation test, the absence of consistent errors cannot be assured, and in producing the aforementioned sample, the thickness and variation in thickness of the sample can have a significant effect on the inspection. Moreover, producing samples is time-consuming and the inspected panel is destroyed.

The present invention primarily aims at an alternative method for inspecting panels, whereby according to various preferred embodiments a solution is provided to the problems which are linked to the methods of the prior art.

To this end, the present invention, according to its first independent aspect, is a process for inspecting panels, wherein the above-mentioned panels are provided, at at least a first pair of opposite edges, with profiled edge aeras which are provided with coupling parts that allow two panels of this kind to be coupled to each other, wherein the above-mentioned coupling parts are substantially made as a tongue and groove, wherein the groove is delimited by means of at least a top and a bottom groove lip and wherein the aforementioned tongue and groove are provided with locking parts which prevent the tongue and groove from moving apart, wherein in the coupled state a locking can be obtained in a direction perpendicular to the plane of the coupled panels, and in a direction in the plane of the coupled panels and perpendicular to the coupled edges, characterized in that the method comprises at least the step of recording at least one first part and one second part of the contour of the cross-section of a first of the above-mentioned profiled edge aeras, wherein the first part and the second parts are recorded by using one or more sensors, wherein the recording of the first part is performed from a first recording angle and that the recording of the second part is performed from a second recording angle different from the above-mentioned first recording angle, but each time from one or more recording directions transverse to the longitudinal direction of the corresponding edge.

By applying two different recording angles, a full image of the contour of the profiled edge area can be formed by means of an inspection transverse to the longitudinal direction, even when rear-or undercut profile parts are present in the corresponding contour. For example, aforementioned locking parts may be formed by means of such rear-or undercut profile parts. There is no doubt that, a full image of the contour need not necessarily be formed. For example, the inspection, and the corresponding recordings of the first and second parts, may be limited to recordings of a first and a second part which, in the aforementioned coupled state, comprise a part of one or more provided contact and/or locking surfaces. The accurate performing of such surfaces is crucial for obtaining and maintaining a proper connection of two panels of this kind in their coupled state. Preferably, sensors are employed that allow to form an image/display of the first and second part of the contour of the cross-section.

Preferably, by means of the first and second parts, at least a part of the contour is recorded that extends, preferably uninterruptedly, from a surface provided as a vertical active contact surface between the upper side of the tongue and the under side of the top lip to a surface provided as a horizontal locking surface, for example provided as a horizontal locking surface on the upper side of the bottom groove lip or on the under side of the tongue. For example, by means of the first and second parts, at least a part of the contour extending, preferably uninterrupted, from the upper surface or decorative surface of the panels to a surface provided as a horizontal locking surface, for example provided as a horizontal locking surface on the upper side of the bottom groove lip or on the under side of the tongue can be recorded. Better still, by means of the first and second parts, at least a part of the contour extending, preferably uninterrupted, from the upper surface or decorative surface of the panels to the under surface of the panels is recorded using the first and second parts.

The aforementioned first and second parts of the contour may or may not overlap and/or may or may not be contiguous. Preferably, the first and second parts are overlapping in their connection. Preferably, such connection takes place on a part of the contour that is free from surfaces provided as contact surfaces and/or locking surfaces. Preferably, such connection takes place on a part of the contour that, in the coupled state, has a free space delimited between the cross-section of the aforementioned tongue and groove.

According to a particular embodiment, the first and second parts comprise at least a common contact surface and/or locking surface, preferably a common vertically active contact surface, for example a vertically active contact surface between the bottom side of the tongue and the upper side of the bottom groove lip. In this way, the recording of the corresponding contact surface and/or locking surface can be performed in a more accurate manner.

The recording of the aforementioned first and second parts can be done in several possible ways.

According to a first possibility, the above-mentioned first and second parts are at least recorded using the same first sensor. Preferably, the above-mentioned first sensor is rotatably arranged, and the above-mentioned first and second recording angles are taken by positioning the above-mentioned first sensor, e.g., rotating it. Setting the recording angle, for example by rotating, may be motorised and/or manual. According to a variant, the first sensor may perform a recording at different angles, for example by allowing the recording medium, such as light in the case of an optical sensor, to be deflected at different angles, such as by means of one or more reflectors or mirrors. Preferably, the first sensor is rotatable at an angle of at least 45°, and better still at an angle of at least 90°.

According to a second possibility, the aforementioned first and second parts are at least recorded by separate sensors. In this regard, the individual sensors are preferably fixedly positioned, or at least fixedly positioned while performing the aforementioned recording. However, the individual sensors may be positioned between recordings, for example for setting the recording. The setting may be motorised and/or manual.

Preferably, the aforementioned recording directions are at right angles to the longitudinal direction of the corresponding edge. In this way, easily repeatable recordings can be made. For example, one or more sensors can be used that are active in a plane at right angles to the aforementioned longitudinal direction.

Preferably, the first and second parts of the contour are in the same plane, or are separated in the longitudinal direction by a distance less than ten times the thickness of the panel. This will ensure that the recording of the first and second parts relate to the same or nearly the same cross-section of the profiled corresponding edge. In this way, analysis of the recording can easily be done, and any diagnosis can be made in connection with observed deviations from the anticipated contour. In the frequently used methods for realising profiled edge areas, and especially in the case where the profiled edge areas are realised using rotary milling tools, varying deviations over a distance in the longitudinal direction of less than ten times the thickness of the panel are not to be expected, and thus an accurate image can still be formed even when the parts are separated in the longitudinal direction. If varying anomalies do occur over such short distances, it is to be expected that such anomalies can be identified without performing advanced inspection techniques and/or that they will come to the fore when the images of the first and second parts are placed side by side.

Preferably, sensors are employed that allow distance and/or profile measurement, e.g., laser distance or laser profile meters. Preferably, such a sensor allows the measurement of distance to multiple points of the corresponding contour part, preferably with a resolution of more than 10 points per millimetre, or even more than 1000 points per millimetre, while the recording angle is constant. This may involve a sensor which is capable of performing a line scan of the corresponding contour part.

According to a particular example, one or more optical 2D triangulation position sensors and/or one or more sensors, namely 2D triangulation position sensors, available on the market under the name Keyence LJ-V7060, are used.

According to the invention, more than two recording angles are not excluded. Preferably, the method further comprises the step of recording a third part of the above-mentioned contour, wherein the recording of the third part takes place from a third recording angle different from the above-mentioned first and second recording angles, but also from one or more recording directions transverse, preferably at right angles to the longitudinal direction of the corresponding edge. Recording of the above-mentioned third part may be done with the same sensor as used for recording the first and/or second part of the contour, or by a separate sensor. If the same sensor is used as for recording the first and/or second part, it is preferably a positionable or rotatable sensor, or a sensor whose recording medium can be deflected, as described above. The third part may overlap in whole or in part with the first and/or second part, or be substantially complementary to the first and second parts. The third recording angle can be located between the first and second recording angles. This is mainly of interest when an overlap with the first and second parts is desired. According to a variant, the third recording angle may be larger and/or opposite to the first and/or second recording angle.

Preferably, the aforementioned first recording angle is located in the plane of the panels, or the first recording angle encloses an angle of 15° or less with this plane.

Preferably, the aforementioned second recording angle is perpendicular to the plane of the panels, or the second recording angle encloses an angle with the vertical of less than 45°, and preferably less than 35°.

According to a particular preferred embodiment, the method comprises the following properties:
the aforementioned first recording angle is located in the plane of the panels, or encloses an angle of 15° or less with this plane;
the aforementioned second recording angle is perpendicular to the plane of the panels, or encloses with the vertical an angle of less than 45°, and preferably less than 35°;
the aforementioned third recording angle, if any, is perpendicular to the plane of the panels, or encloses with the vertical an angle of less than 45°, and preferably less than 35°, but such that the third recording direction comprises a vertical component which is opposite to the aforementioned second recording direction.

Preferably, the aforementioned bottom lip extends distally beyond the aforementioned top lip, and the aforementioned locking parts comprise a protrusion on the upper surface of the aforementioned bottom lip, and a recess at the under side of the aforementioned tongue, where, in the aforementioned coupled state, horizontally active locking surfaces are formed, on the one hand, on a proximal surface of the aforementioned protrusion and, on the other hand, on a distal surface of the aforementioned recess. It is with couplings parts and locking parts of this kind that the method of the present invention works at its best. With such coupling parts and locking parts, a rear-or undercut part may occur, for example adjacent to the aforementioned proximal surface of the protrusion and/or adjacent to the aforementioned distal surface of the recess. Such rear-or undercut parts of the contour may, during recording from the first recording angle or from the second recording angle, lie in the shade of the aforementioned protrusion or the under side of the aforementioned tongue, respectively, so that by recording from only one recording angle, only an incomplete image of the contour of the corresponding profiled edge area can be formed.

Preferably, the first part and/or the second part of the contour comprises at least one of the aforementioned horizontally active locking surfaces.

Preferably, the above-mentioned second recording angle corresponds or nearly corresponds to the average angle over which the above-mentioned horizontal active locking surface extends on the to be inspected first profiled edge area. Preferably, the aforementioned second recording angle deviates from the above-mentioned average angle by no more than 10°, or by no more than 5°.

Preferably, in the aforementioned coupled condition, vertically active contact surfaces are formed on the upper side of the aforementioned tongue and the under side of the aforementioned top groove lip, wherein the aforementioned vertically active contact surfaces are parallel to the plane of the panels, or wherein the aforementioned vertically active contact surfaces make an angle or an average angle with the plane of the panels of 45° or less, preferably of 15° or less. Such vertically active contact surfaces may lie in the shade of the aforementioned bottom groove lip, certainly in cases where the bottom groove lip extends beyond the top groove lip, so that only an incomplete image of the contour of the corresponding profiled edge aera can be formed from only one recording angle.

Preferably, the first part and/or the second part of the contour comprises at least one of the aforementioned vertically active locking surfaces. Preferably, the aforementioned first recording angle deviates at most 10°, or at most 5° from this average angle.

Preferably, the aforementioned first recording angle corresponds or nearly corresponds to the average angle over which the aforementioned vertically active contact surfaces extend.

According to the most preferred embodiment, the first recording angle corresponds or nearly corresponds to the average angle over which the aforementioned vertically active contact surfaces extend and the second recording angle corresponds or nearly corresponds to the average angle over which the aforementioned horizontally active locking surfaces extend.

Preferably, the aforementioned first profiled edge area comprises the aforementioned groove.

Preferably, the method further comprises the step of recording at least a part of the contour of the cross-section of the second of the above-mentioned profiled edge aeras, for example of the profiled edge aera which comprises the tongue. Preferably, the recording angles at which the one or more sensors are active, when recording the corresponding parts of both profiled edge aeras, are identical or deviate from each other only by 5° or less. Such an embodiment allows the same device to be used to inspect both profiled edge areas. However, it is not excluded that a separate device, preferably an identical or similar device, may be used to inspect the second, opposite, profiled edge aera. The one or more sensors for recording the second profiled edge area may be part of one and the same device which comprises the sensors for recording the first profiled edge area. The recording of the first and second profiled edge area may be performed simultaneously or quasi simultaneously and/or without the need to reposition the to be inspected panel.

Preferably, the aforementioned panel, at at least a second pair of opposite edges, is provided with profiled edge aeras which are provided with coupling parts that allow two panels of this kind to be coupled to each other, and wherein the method comprises the step of recording a part of one or both profiled edge aeras of the second pair of opposite edges. Preferably, when recording the corresponding parts of both profiled edge aeras of the second pair, the recording angles at which the one or more sensors are active are identical or differ from each other only by 5° or less. Preferably, the corresponding recording angles are also identical, or deviate only by 5° or less, from the recording angles which are applied for inspecting one or both profiled edge areas of the first pair. Such an embodiment allows the use of the same device to inspect both pairs of profiled edge areas. However, it is not excluded to use a separate device, preferably an equal or similar device, for inspecting one or both profiled edge areas of the second pair of profiled edge areas. The one or more sensors for recording one or both edge areas of the second pair of profiled edge areas may be part of one and the same device which comprises the sensors for recording one or both edge areas of the first pair of profiled edge areas. The recording of the first and second pair of profiled edge areas may be performed simultaneously or quasi simultaneously and/or without the need for repositioning of the to be inspected panel.

The coupling parts of the second pair of opposite edges may also be substantially made as a tongue and a groove which is provided with locking parts that prevent the moving apart of tongue and groove. According to a variant, the second pair of opposite edges comprises coupling parts substantially made as a male coupling part and a female coupling part, wherein the male coupling part may be inserted into the female coupling part by means of a downward movement. These may be, for example, coupling parts as described in WO 2021/111210, WO 01/75247, EP 2 440 724, or WO 2009/066153, which may or may not form one piece with the panel material.

Preferably, in a coupled condition of two panels of this kind, at the second pair of opposite edges also occurs a locking between the corresponding edges in a direction perpendicular to the plane of the coupled panels and in a direction in the plane of the coupled panels and perpendicular to the coupled edges.

According to a particular embodiment, the aforementioned first profiled edge aera may perform a movement in longitudinal direction, preferably motorised, relative to the aforementioned one or more sensors. For example, the sensors may be movably arranged, preferably while the panel is fixed. In this way, recordings of the first and/or second part can be made at different locations along the profiled edge area. The recordings of the first and second parts may be performed alternately, but preferably such that a second part is disposed away from a first part over a distance of less than ten times the thickness of the panel.

For the same object as in the first aspect, the present invention, according to a second independent aspect, is a process for performing a quality control on panels, wherein the above-mentioned panels at at least a first pair of opposing edges are provided with profiled edge aeras which are provided with coupling parts that allow two panels of this kind to be coupled to each other, wherein the above-mentioned coupling parts are substantially made as a tongue and a groove, wherein the groove is at least delimited by means of a top and a bottom groove lip, and wherein the above-mentioned tongue and groove are provided with locking parts that prevent the moving apart of the tongue and groove, wherein in the coupled state a locking can be obtained in a direction perpendicular to the plane of the coupled panels, and in a direction in the plane of the coupled panels and perpendicular to the coupled edges, characterised in that the method comprises at least the following steps:
the step of inspecting the panels in accordance with the method of the first independent aspect and/or its preferred embodiments, wherein at least a first and second part of the contour of the cross-section of a first of the aforementioned profiled edge areas are recorded; and
the step of directly or indirectly comparing at least one of the aforementioned parts with the desired geometry of the corresponding part.

By using the method of inspection from the first independent aspect, quality control can smoothly be realized without having to produce samples from the corresponding edge areas. The quality control can be performed non-destructively in its entirety, moreover, it is less or not dependent on the person performing the quality control.

The method of the second independent aspect may lead to a more reliable production of panels which are provided with coupling parts. Accordingly, it is clear that the present invention according to a particular independent aspect also relates to a method of manufacturing panels, wherein a quality control with the features of the second independent aspect, and/or the preferred embodiments thereof is applied. Optionally, this may involve checking every panel produced, or regular or randomly scheduled sampling. For example, one or more panels per hour can be inspected at one or more of the profiled edge areas. The recordings can be compared with the desired geometry of the corresponding part of the recorded profiled edge area.

Preferably, deviations obtained in the aforementioned step of comparison are stored, and the aforementioned deviations preferably form the basis of a statistical process control, for example applied to the process of forming the corresponding profiled edge areas. A static process control and/or monitoring may allow to monitor or predict tool wear, such that they can, for example, be replaced preventively.

Preferably, deviations obtained in the aforementioned step of comparison are used for automatically or non-automatically controlling the process of forming the corresponding profiled edge areas. In case the corresponding profiled edge areas are formed using a mechanical cutting operation with several successive rotary milling tools, the position of one or more of the rotary milling tools may be adjusted.

For the same object as in the first and second aspects, the present invention, according to its third independent aspect, is a device for use in a method according to any of the preceding aspects and/or the preferred embodiments thereof, characterized in that the above-mentioned device comprises at least the above-mentioned one or more sensors.

Preferably, the device which are provided with means for clamping the corresponding panel and/or means for aligning or positioning the corresponding panel with respect to the aforementioned sensors. These means may individually or in combination ensure a more repeatable inspection result.

Preferably, the aforementioned device automatically proceeds to the recording of the corresponding part of the contour and/or comprises means for initiating the step of recording the corresponding part of the contour, such means being user activatable. This may comprise, for example, a push button, a touch button, a contact activatable by sound or voice, a contact activatable by light or shadow, a contact activatable by wireless or wired remote control, and the like.

Preferably, the device comprises a handle and/or the device is provided with a housing suitable for placing or mounting on a surface, such as on a wall or on a table.

Preferably, the device comprises indication means that allow information to be made available regarding the quality and/or result of the measurement. The indication means may comprise, for example, light indicators, such as a light beacon, and/or sound indicators, such as a sound when the measurement has been performed, wherein this light and/or sound may possibly be different for a well performed and a poorly performed measurement, and/or may be different for a measurement result that meets the imposed tolerances and a measurement result that does not meet the imposed tolerances.

Preferably, the device comprises one or more illumination elements, wherein the above-mentioned illumination elements preferably allow the corresponding profiled edge aera to be illuminated according to two or more directions, preferably transverse or at right angles to the longitudinal direction of the corresponding profiled edge aera. The directions preferably correspond at least or nearly correspond to the aforementioned first and second recording angles, wherein any deviation between a corresponding direction and a corresponding recording angle is preferably 15° or less, or even 5° or less.

Preferably, the device comprises means for storing at least a part of the recording data, for reading at least a part of the recording data, for printing at least a part of the recording data, for displaying at least a part of the recording data and/or for transmitting at least a part of the data to a computer or computer network. Preferably, the device is provided with an integrated and possibly removable data carrier for this object.

In the context of the present invention, the term “recording angle” denotes the average angle over which the corresponding sensor makes a recording. In the case of sensors of which recording medium impinges pointwise on the edge aera, the recording angle is the angle at which the recording medium impinges on the edge aera, considered in a plane perpendicular to the longitudinal direction of the corresponding edge aera. In the case of sensors of which the recording medium strikes the edge area at least linearly, the angle of recording is the average angle at which the recording medium strikes the edge area, considered in a plane perpendicular to the longitudinal direction of the edge area concerned.

It is further noted that the aforementioned method of inspecting panels or for carrying out quality control of panels, and the aforementioned device can also be applied to panels which are provided with profiled edge areas having a shape other than a tongue and groove. The skilled person understands that similar advantages can be achieved when only one of the opposite profiled edge areas comprises a coupling part in the form of a tongue or a groove, or when both of the opposite edge areas comprise the same type of coupling part, such as both a tongue or both a groove. It is further understood that coupling parts that do not have a distinct tongue and groove shape can also be inspected using the device and/or the methods of the present invention. Instead of being substantially made as a tongue and groove, such coupling parts may be substantially made as a male coupling part and a female coupling part, wherein the male coupling part may be inserted into the female coupling part by means of a downward movement. In the coupled state, a locking occurs preferably between the corresponding edges in a direction perpendicular to the plane of the coupled panels, and in a direction in the plane of the coupled panels and perpendicular to the coupled edges. Such male and female coupling parts preferably also comprise horizontally active locking surfaces and vertically active contact surfaces in the coupled state. Rear-or undercut profile parts may also be used to achieve the locking. An inspection and/or quality control technique and in the direction similar to that described in the context of the described aspects of the invention thus also find good application here.

It is further understood that the profiled edge aeras of the to be inspected panels, in the context of the present invention, preferably extend continuously and invariably along substantially the entire longitudinal direction of the corresponding profiled edge aera, for example possibly with the exception of the ends thereof. However, it is not excluded that the techniques described herein may be applied for inspecting or controlling local incisions or profiled edge aeras with profilings that vary in the longitudinal direction of the profiled edge aera, as for example for controlling the long pair of profiled edge aeras of the panels described in WO 2020/109961.

With the understanding to better demonstrate the characteristics of the invention, some preferred embodiments are described below, as examples without any limiting character, with reference to the corresponding drawings, wherein:

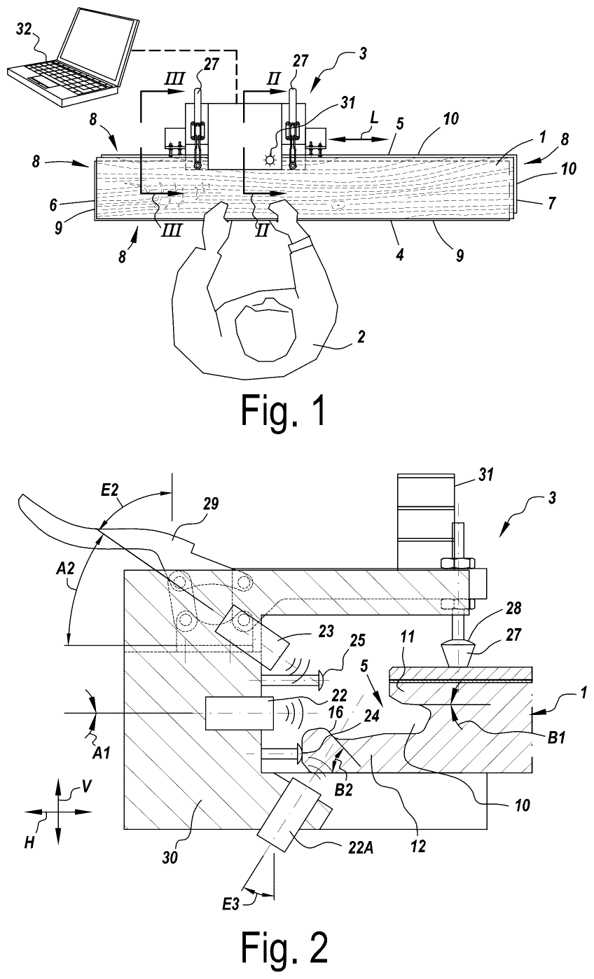

FIG. 1 in top view shows a step in a method for inspecting panels according to the invention;

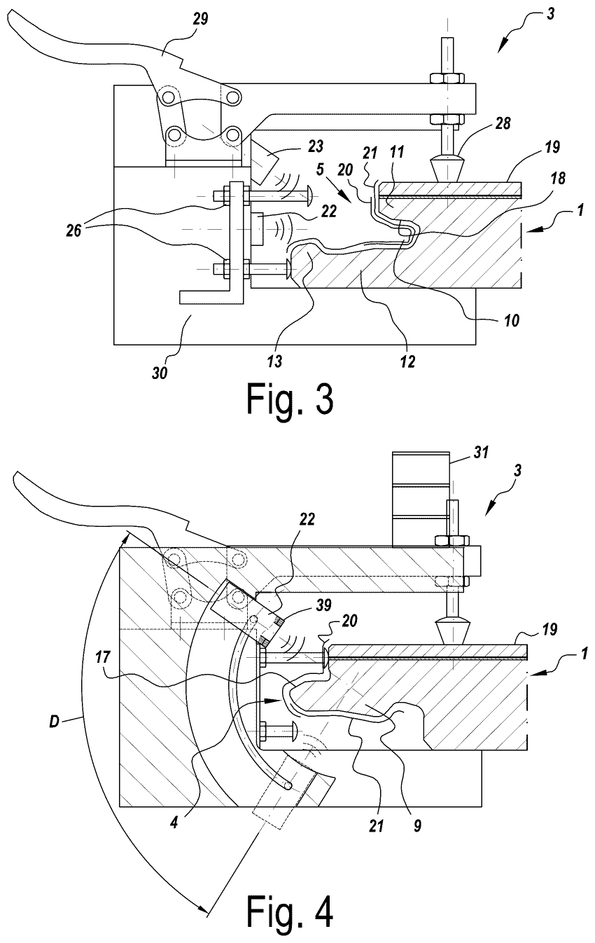

FIGS. 2 and 3 show on a larger scale cross-section according to lines II-II and III-III shown in FIG. 1, respectively;

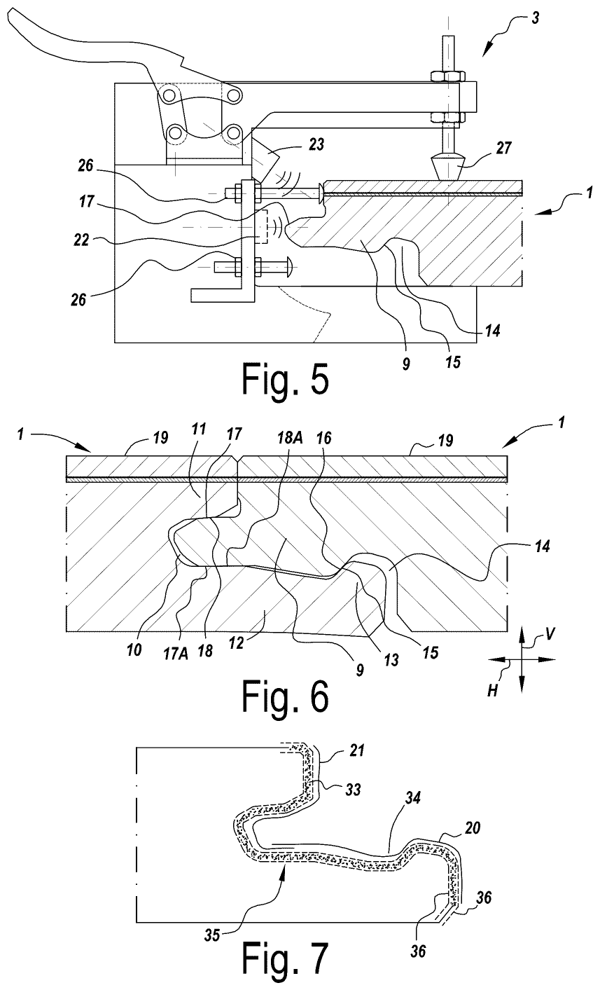

FIGS. 4 and 5 in similar views as FIGS. 2 and 3 show a variant;

FIG. 6 shows the coupled state of two of the panels from the previous figures;

FIG. 7 shows a recording obtained by means of the method described in FIGS. 1 to 3; and

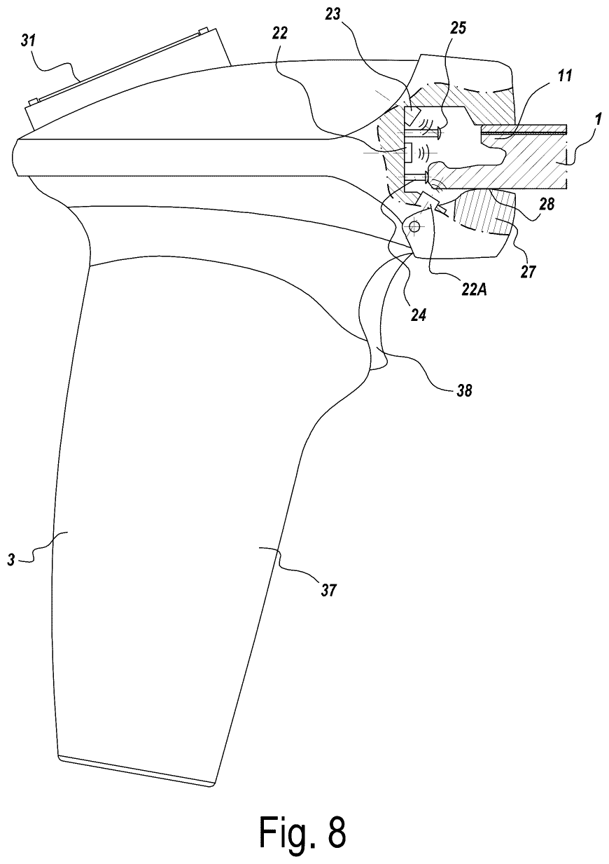

FIG. 8 in a view similar to that of FIG. 2 shows a variant.

FIG. 1 shows in top view the fact that a panel 1 is presented by an operator 2 to a device 3 for inspecting panels 2. In the example, it concerns an elongated and rectangular panel 1 that is provided at both pairs of opposite edges 4-5-6-7 which are provided with profiled edge areas which are provided with coupling parts 8 which allow two panels 1 of this kind to be coupled to each other. At the long pair of opposite edges 4-5, the coupling parts 8 are substantially made as a tongue 9 and a groove 10.

FIGS. 2 and 3 clearly show that the groove 10 is at least delimited by means of a top groove lip 11 and a bottom groove lip 12, wherein the bottom groove lip 12 extends distally beyond the top groove lip 11.

FIGS. 4 and 5 show the edge 4 which is provided with the tongue 9.

FIG. 6 shows that the aforementioned tongue 9 and groove 10 are provided with locking parts that prevent the tongue 9 and groove 10 from moving apart. The locking parts comprise a protrusion 13 on the upper surface of the bottom groove lip 12, and a recess 14 at the lower surface of the above-mentioned tongue 9, wherein, in this case, in the coupled state shown here, horizontally active locking surfaces 15-16 are formed, on the one hand, on a proximal surface of the above-mentioned protrusion 13, and, on the other hand, on a distal surface of the above-mentioned recess 14.

FIG. 4 further shows that, in the coupled state, vertically active contact surfaces 17-18 are formed on the upper side of the tongue 9 and the under side of the aforementioned top groove lip 11. In the example, these vertically active contact surfaces 17-18 are parallel to the plane 19 of panels 1.

In the coupled state, a locking occurs in a vertical direction V perpendicular to the plane 19 of the coupled panels 1 and in a horizontal direction H in the plane 19 of the coupled panels 1 and perpendicular to the coupled edges 4-5.

FIGS. 1 to 3 show that, by using the aforementioned device 3, at least a first part 20 and a second part 21 of the contour of the cross-section of the first profiled edge aera, namely the edge aera at the edge 5 with the groove 10, are recorded using two separate sensors 22-23, namely a first sensor 22 and a second sensor 23. In this case, these are optical sensors, more specifically 2D triangulation position sensors. The recording of the first part 20 takes place from a first recording angle A1, and the recording of the second part 21 takes place from a second recording angle A2 that is different from the aforementioned first recording angle. Both recordings occur from recording directions transverse, and in this case at right angles, to the longitudinal direction L of the corresponding edge.

In the example, the first recording angle A1 is located in the plane 19 of the panel 1. The second recording direction makes a recording angle A2 with the plane 19 of the panel 1 of less than 45°, in this case about 55°. The first recording angle A1 herein corresponds to the average angle B1 over which the aforementioned vertically active contact surface 18 on the under side of the top groove lip 11 extends. The second recording angle A2 corresponds herein to the average angle B2 over which the aforementioned horizontally active locking surface 16 extends, i.e., in an uncoupled state.

FIGS. 4 and 5 show an alternative device 3, wherein a first part 20 and a second part 21 of the contour are recorded using the same first sensor 22. For this object, the first sensor 22 is rotatably arranged. The aforementioned first recording angle A1 and second recording angle A2 are then taken by rotating the first sensor.

FIGS. 4 and 5 further show that a similar inspection technique may be employed for recording a first part 20 and second part 21 of the profiled edge aera at the edge 4 which is provided with the tongue 9. This may of course also be carried out with the device 3 shown in FIGS. 1 to 3. For this object, the device 3 may be provided with an additional sensor 22A for recording the aforementioned second part 21 in the case of the inspection of an edge aera at an edge 4 which is provided with a tongue 9. Due to the rotatable arrangement over an angle D of more than 60°, and in this case even an angle D of more than 90°, the device 3 illustrated in FIGS. 4 and 5 allows inspecting both an edge aera at an edge 4 which is provided with a tongue 9 and at an edge 5 which is provided with a groove 10 with only one sensor 22.

The above-mentioned third sensor 22A may also be employed for recording a third part of the contour of the edge which is provided with the tongue 9 or the groove 10, wherein the recording of the third part is then provided preferably from a third recording angle different from the above-mentioned first recording angle A1 and second recording angle A2, but preferably also from a recording direction transverse to the longitudinal direction L of the corresponding edge 4-5. Recording a third part is also possible using only one sensor 22, for example a rotatable sensor 22, as shown in FIGS. 4 and 5.

The devices 3 of FIGS. 1 to 5 are provided with means 24-25 for aligning or positioning the panel 1 with respect to the aforementioned sensors 22-23-22A.

In the example, the aforementioned means 24-25 comprise two pins correspondingly forming a stopping surface for an edge 4 which is provided with a tongue 9, or for an edge 5 which is provided with a groove 10. The position of the stopping surface is hereby adjustable by means of screws 26.

The devices 3 of FIGS. 1 to 5 are further provided with means 27 for clamping the corresponding panel 1. In the example, the means 27 for clamping comprise a clamping part 28 that can be pressed onto the surface 19 of the panel 1 by means of a lever 29.

In the examples, the device 3 is equipped with a housing 30 suitable for the placement on a surface, such as a table.

The device is further equipped with indication means 31 in the form of a light beacon that allows a light signal to be given in accordance with the quality of the recording. The result of the inspection, for example the recording data, can be read out using a computer 32.

Of course, one or both of the short pair of opposite edges 6-7 can also be subjected to a similar inspection with the same or similar device 3.

FIG. 7 shows recording data 33 which are obtained by means of the device of FIGS. 1 and 2. FIG. 5 shows the recording of the first part 20 and the second part 21 of the contour. The recording of the first part 20 partially overlaps with the recording of the second part 21. The under-or back-cut part 34 of the groove 10, adjacent to the proximal surface of the protrusion 13, is, in the example, each time at least in part only recorded by one of the two recordings. An overlap is also provided at the transition 35 between the first part 20 and the second part 21. The aforementioned first part 20 comprises in this case the horizontally active locking surface 16 of the groove 10. The aforementioned second part 21 comprises in this case the vertically active contact surface 18 on the under side of the top groove lip 11. The transition 35, or in this case the overlap, between the first part 20 and the second part 21 occurs at the level of the vertically active contact surfaces 17A-18A between the under side of the tongue 9 and the upper side of the bottom groove lip 12.

FIG. 7 further shows that the obtained recording data 33 can be compared with the desired geometry. In this case, by means of the dashed lines 36 a tolerance zone is indicated that represents the limits for approval and rejection in the context of a quality control according to the second aspect.

FIG. 8 shows an alternative device 3 for inspecting panels 1 in an embodiment according to the first aspect. In particular, it concerns a device 3 which is provided with a handle 37. The device is also provided with means 27 for clamping the panel and indication means 31 that allow information to be made available in relation to the quality and/or result of the recording. In the example, the means 27 are active on the under side of the panel 1. In this case, the indication means 31 are made as a screen facing away from the to be inspected panel 1. In the example, the screen is located on the upper side of the device 3, so that it is ergonomically readable for the operator 2.

FIG. 8 further shows that the device 3 is provided with means 38 for starting the step of recording the corresponding part 20-21 of the contour. In particular, this involves a push button that can be activated by the operator 2.

The embodiment of FIG. 8 allows an ergonomic handling of the device 3, which is easily portable or transportable from one quality control site to another.

It will be noted that FIG. 4 further illustrates that the device 3 may comprise one or more illumination elements 39, wherein the above-mentioned illumination elements 39 allow to illuminate the corresponding profiled edge aera according to two or more directions, preferably transverse to the longitudinal direction L of the corresponding profiled edge aera. In this case, the illumination elements 39 are integrated into the sensor 22 and are therefore also rotatably arranged. In the example, the illumination elements 39 are ring-shaped around the sensor 22 itself.

The devices 3 from the figures are suitable for the performing of the in the introduction mentioned particularly preferred embodiment, wherein:
the aforementioned first recording angle is located in plane 19 of panels 1, or forms with this plane 19 an angle A1 of 15° or less;
the aforementioned second recording angle is perpendicular to the plane of the panels, or encloses with the vertical an angle E2 of less than 45°, and preferably less than 35°; and
the aforementioned third recording angle is perpendicular to the plane 19 of panels 1, or encloses with the vertical an angle E3 of less than 45°, and preferably less than 35°, but such that the third recording direction comprises a vertical component which is opposite to the aforementioned second recording direction.

The present invention is by no means limited to the embodiments described as examples and shown in the figures, but such methods and devices 3 may be realised in several ways without going beyond the scope of the invention.

1.-24. (canceled)

25. A method for inspecting panels, wherein the panels at least at one first pair of opposite edges are provided with profiled edge areas which are provided with coupling parts allowing two of such panels to be coupled to each other,
wherein the above-mentioned coupling parts are substantially made as a tongue and a groove,
wherein the groove is at least delimited by means of a top groove lip and a bottom groove lip, and
wherein the above-mentioned tongue and groove are fitted with locking parts which prevent the tongue and groove from moving apart,
wherein, in the coupled state, a locking can be obtained between the relevant edges in a direction perpendicular to the plane of the coupled panels, and in a direction in the plane of the coupled panels and perpendicular to the coupled edges,
wherein the method comprises at least the step of recording at least one first part and second part of the contour of the cross-section of a first of the above-mentioned profiled edge areas,
wherein the first part and the second part are recorded by using one or more sensors,
wherein the first part is recorded from a first recording angle, and that the second part is recorded from a second recording angle different from the first recording angle, but each time, from one or more recording directions transverse to the longitudinal direction of the corresponding edge.

26. The method according to claim 25, wherein the above-mentioned first part and second part are at least recorded using one and the same first sensor.

27. The method according to claim 26, wherein the above-mentioned first sensor is positioned rotatable and that the above-mentioned first recording angle and second recording angle are taken by rotating the above-mentioned first sensor.

28. The method according to claim 25, wherein the above-mentioned first part and second part are at least recorded by separate sensors.

29. The method according to claim 25, wherein the above-mentioned recording directions are at right angles to the longitudinal direction of the edge concerned.

30. The method according to claim 25, wherein the above-mentioned first recording angle is situated in the plane of the panels, or forms an angle therewith of 15° or less.

31. The method according to claim 25, wherein the above-mentioned second recording angle is perpendicular to the plane of the panels, or forms an angle therewith of less than 45°.

32. The method according to claim 25, wherein the method further comprises the step of the recording of a third part of the above-mentioned contour,
wherein the recording of the third part takes place from a third recording angle different from the above-mentioned first and second recording angles, but also from one or more recording directions transverse to the longitudinal direction of the corresponding edge.

33. The method according to claim 25, wherein the above-mentioned bottom groove lip extends in distal direction beyond the above-mentioned top groove lip, and the above-mentioned locking parts comprise a protrusion on the upper surface of the said bottom lip, and a recess at the bottom of the above-mentioned tongue,
wherein, in the above-mentioned coupled state, horizontally active locking surfaces are formed, on the one hand, on a proximal surface of the said protrusion and, on the other hand, on a distal surface of the said recess.

34. The method according to claim 33, wherein the above-mentioned second recording angle corresponds or almost corresponds to the average angle over which the said locking surface extends on the to be inspected first profiled edge area.

35. The method according to claim 33, wherein, in the above-mentioned coupled state, vertically active contact surfaces are formed on the top of the above-mentioned tongue and the bottom of the above-mentioned top groove lip,
wherein the above-mentioned vertically active contact surfaces are parallel to the plane of the panels, or form with it an average angle of 45° or less.

36. The method according to claim 35, wherein the above-mentioned first recording angle corresponds or almost corresponds to the average angle over which the above-mentioned vertically active contact surfaces extend.

37. The method according to claim 25, wherein the above-mentioned first profiled edge area comprises the above-mentioned groove.

38. The method according to claim 25, wherein the method further comprises also the step of recording at least a part of the contour of the cross-section of the second of the above-mentioned profiled edge areas.

39. The method according to claim 25, wherein the above-mentioned panel, at least at a second pair of opposite edges, is provided with profiled edge areas which are provided with coupling parts allowing two of these panels to be coupled together, and
wherein the method also comprises the step of recording a part of one or both profiled edge areas of the second pair of opposite edges.

40. A method for conducting a quality control on panels, wherein the panels, at least at one first pair of opposite edges, are provided with profiled edge areas which are provided with coupling parts allowing two of these panels to be coupled together,
wherein the above-mentioned coupling parts are essentially made as a tongue and a groove,
wherein the groove is at least limited by means of a top groove lip and a bottom groove lip, and
wherein the above-mentioned tongue and groove are provided with locking parts which prevent the tongue and groove from moving apart,
wherein, in the coupled condition, a locking can be obtained in a direction perpendicular to the plane of the coupled panels and in a direction in the plane of the coupled panels and perpendicular to the coupled edges,
wherein the method comprises at least the following steps:
the step of inspecting the panels in accordance with the method from claim 25,
wherein at least a first part and a second part of the contour of the cross-section of a first one of the above-mentioned profiled edge areas is recorded; and
the step of directly or indirectly comparing at least one of the above-mentioned parts with the desired geometry of the part concerned.

41. The method according to claim 40, wherein deviations obtained in the above-mentioned step of comparing are stored.

42. The method according to claim 41, wherein the deviations form the basis of a statistical process control.

43. The method according to claim 40, wherein deviations obtained in the above-mentioned step of the comparing are used for a control of the process of forming the relevant profiled edge areas.

44. The method of claim 43, wherein the control is an automatic control.
